(19) United States
(12) Patent Application Publication
(10) Pub. No.: US 2008/0000118 A1
(43) Pub. Date: Jan. 3, 2008

(54) DISPLAY APPARATUS FOR SALES PROMOTION

(75) Inventor: Takeo SUZUKI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/767,662

(22) Filed: Jun. 25, 2007

(30) Foreign Application Priority Data
Jun. 29, 2006 (JP) 2006-180106

(51) Int. Cl. G09F 3/00; B65D 5/42

(52) U.S. Cl. 40/312; 206/736

(57) ABSTRACT

A display apparatus for sales promotion, which is formed by folding a sheet, comprises a slit and first and second support portions. The slit extends within the sheet to have first and second ends. The first and second support portions are divided by the slit. The first support portion is subjected to a valley fold along a first crease line, which perpendicularly extends from the slit between the first and second ends. The second support portion is subjected to valley folds along second crease lines, which perpendicularly extend from the slit at the first and second ends, whereby an opening is formed, into which apart of the commodity can be inserted.

### BACKGROUND OF THE INVENTION

1. Field of the Invention

The present invention relates to a display apparatus for sales promotion, or POP (i.e., Point-Of-Purchase display), which is used when displaying a commodity such as a digital camera in a shop window, for example.

2. Description of the Related Art

A POP is displayed with a commodity, or applied on a surface of the commodity, in order to inform customers of the manufacturer, the performance, the price and so on, in a shop. The material of a POP can be paper-based, such as coated paperboard, for example, or a sticker may also be used as POP.

If the POP is an assembly type and placed on a show case together with the commodity, the POP has to be assembled in a shop, which is time-consuming. On the other hand, in the case of a POP being applied to the surface of a commodity, the size of the sticker is restricted depending upon the applied position, causing a problem due to which characteristics of the commodity and so on may not be sufficiently indicated.

### SUMMARY OF THE INVENTION

Therefore, an object of the present invention is to provide a display apparatus for sales promotion which has a simple structure and can be easily assembled, and further, has sufficient space to display information such as the characteristics of the commodity.

According to the present invention, there is provided a display apparatus for sales promotion which is formed by folding a sheet; the display apparatus being displayed with a commodity in a shop; the display apparatus comprising a slit and first and second support portions. The slit extends within the sheet to have first and second ends. The first and second support portions are divided by the slit. The first support portion is subjected to a valley fold along a first crease line, which perpendicularly extends from the slit between the first and second ends. The second support portion is subjected to a valley fold along second crease lines, which perpendicularly extend from the slit at the first and second ends, whereby an opening is formed, into which a part of the commodity can be inserted.

### BRIEF DESCRIPTION OF THE DRAWINGS

The objects and advantages of the present invention will be better understood from the following description, with reference to the accompanying drawings in which:

FIG. 1 is a perspective view of a package, to which a first embodiment of the present invention is applied, when viewed from an upper side thereof;

FIG. 2 is an example of usage of a POP formed from an attached fragment of the package;

FIG. 3 is a plan view showing a flexible sheet, from which the package is cut out;

FIG. 4 is a plan view showing the attached fragment;

FIG. 5 is a perspective view showing the POP; and

FIG. 6 is a plan view showing a flexible sheet, from which the package is cut out, in a second embodiment.

### DESCRIPTION OF THE PREFERRED EMBODIMENTS

The present invention will be described below with reference to embodiments shown in the drawings.

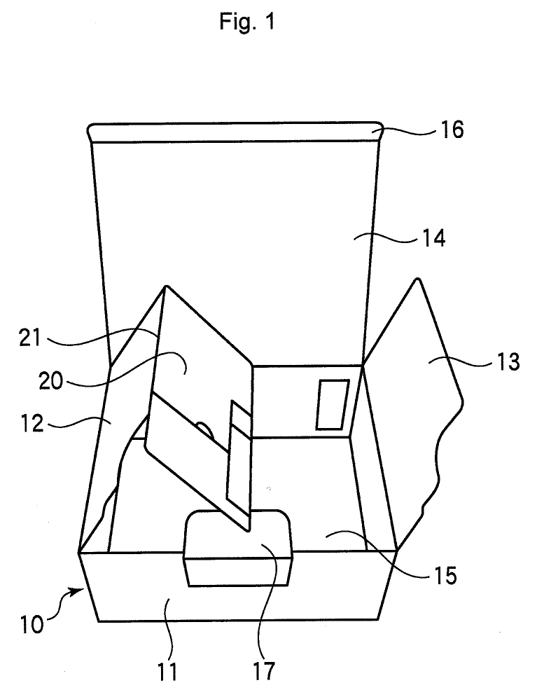

FIG. 1 is a perspective view of a package, to which a first embodiment of the present invention is applied, when viewed from an upper side thereof.

The package 10 can be used to contain a commodity; for example, a camera and an accessory thereof. The package 10 is a rectangular parallelepiped structure, having a body portion 11 for containing a camera and an accessory, a pair of flaps 12 and 13 for covering an opening of the body portion 11, an outer lid 14 for fully closing the opening, and a bottom 15. A tip portion 16 of the outer lid 14 is folded inwards towards the body portion 11. A projecting fragment 17, which is inserted into a slit (not shown) formed in the folded portion of the tip portion 16, is formed on an upper portion of the front side of the body portion 11.

An attached fragment 20 is connected to the flap 12 with perforations 21, so that the attached fragment 20 can be cut off from the flap 12. The attached fragment 20 is a POP for utilization in a shop as a display apparatus for sales promotion, which is used together with the package 10 in a shop. Namely, the attached fragment 20 is cut from the flap 12 in a shop, and assembled and displayed with the commodity as a POP in the shop window.

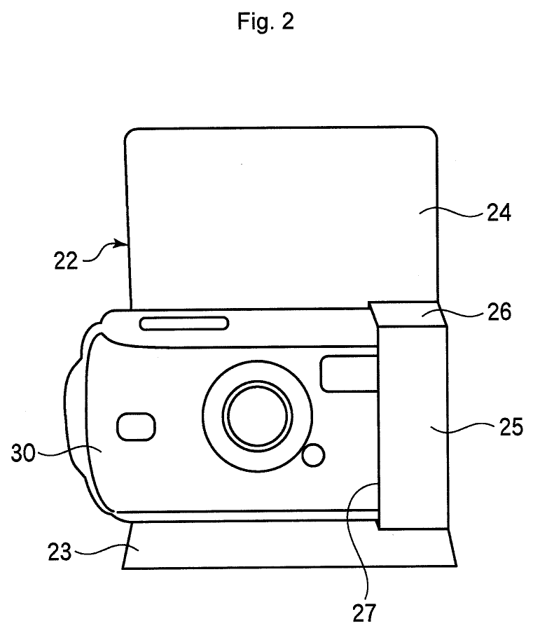

FIG. 2 shows a POP 22 formed from the attached fragment 20. The POP 22 is formed or constructed by folding the attached fragment 20, which is a sheet of cardboard or other material. The POP 22 has a base plate 23, which is placed on a horizontal surface such as the upper surface of a showcase and so on, and a rear surface support plate 24, which is raised upwardly from the base plate 23. A front wall portion 25 is raised upwardly from the base plate 23, and an upper end of the front wall portion 25 and the rear surface support plate 24 are connected to each other through an upper plate 26. The front wall portion 25 and the upper plate 26 form an opening 27, into which a commodity (e.g., a camera) 30 can be inserted. The commodity 30 is displayed in the shop window by being placed on the base plate 23 with an end portion of the commodity 30 inserted into the opening 27. Information, such as the characteristics of the commodity 30, is printed on the base plate 23, the rear surface support plate 24, the front wall portion 25, and the upper plate 26.

The package 10 is assembled as a box shape by folding a paper pattern punched out in a predetermined shape from a flexible sheet, using a cutting die. The flexible sheet is usually a sheet of paper-based material such as coated paperboard, cardboard, corrugated paper, and soon, and can also be a sheet made of plastic.

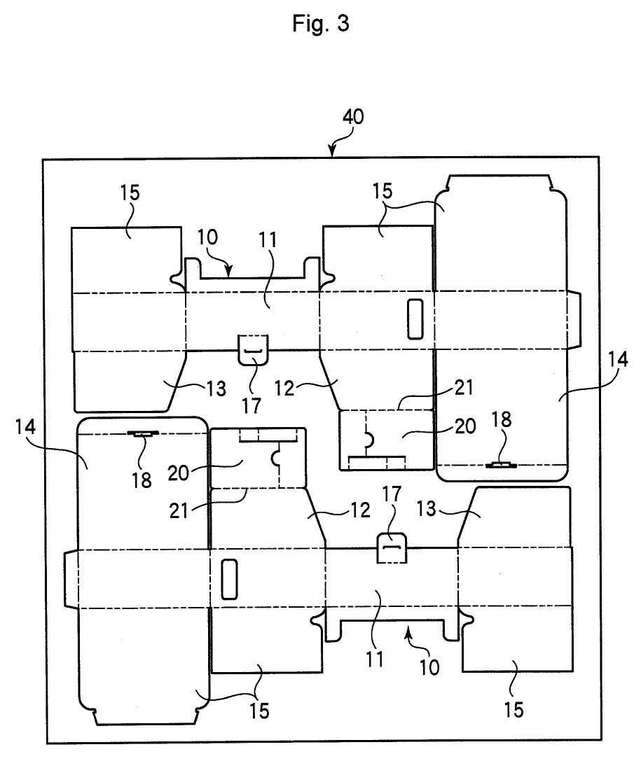

FIG. 3 shows a flexible sheet 40, from which the package 10 is cut out. In the flexible sheet 40, two packages 10 are formed in a developed state, and can be cut out. Within the flexible sheet 40, the package 10 is constructed in such a manner that the flaps 12 and 13, the outer lid 14, the bottom 15, and the projecting fragment 17 are connected to the body portion 11. The tip portion 16 of the outer lid 14 is formed with a slit 18, into which the tip portion 17 is inserted.

In the flexible sheet 40, each of the packages 10 is arranged in a point of symmetry with respect to the center of the flexible sheet 40. Namely, the two strip-shaped body-portions 11 are arranged in parallel, the bottoms 15 are positioned outside, and the flaps 12 and 13, the outer lid 14, and the projecting fragment 17 are positioned inside. The attached fragment 20 is provided on the tip of the flap 12, i.e., at a position facing the other package 10, and the line of the perforations 21 is parallel to the body portion 11. The two attached fragments 20 are formed around the center of the flexible sheet 40.

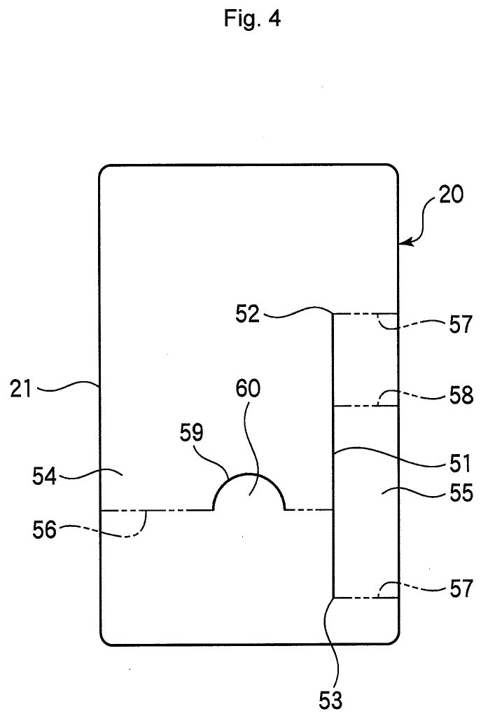

FIG. 4 is a plan view showing the attached fragment 20 in enlargement. The attached fragment 20 is a rectangular sheet, one long side of which is connected to the flap 12 through the perforations 21. A slit 51 is formed in a side close to the other long side of the rectangular sheet. The slit 51 is formed in such a manner that the rectangular sheet is cut so that the ends of the slit do not reach the edges of the attached fragment 20, in order that the slit 51 has first and second ends 52 and 53. The attached fragment 20 is divided into first and second support portions 54 and 55. The second support portion 55 is provided at an opposite side of the perforations 21. The second support portion 55 has a breadth, perpendicular to the slit 51, shorter than that of the first support portion 54.

A first crease line 56, which perpendicularly extends from the slit 51 between the first and second ends 52 and 53, is formed in the first support portion 54. A semicircular slit 59 is formed in the first support portion 54, and both ends of the semicircular slit 59 a repositioned on the first crease line 56. Second creases 57, which perpendicularly extend from the slit 51 at the first and second ends 52 and 53, are formed in the second support portion 55. A third crease line 58, which perpendicularly extends from the slit 51 between the first and second ends 52 and 53, is formed in the second support portion 55.

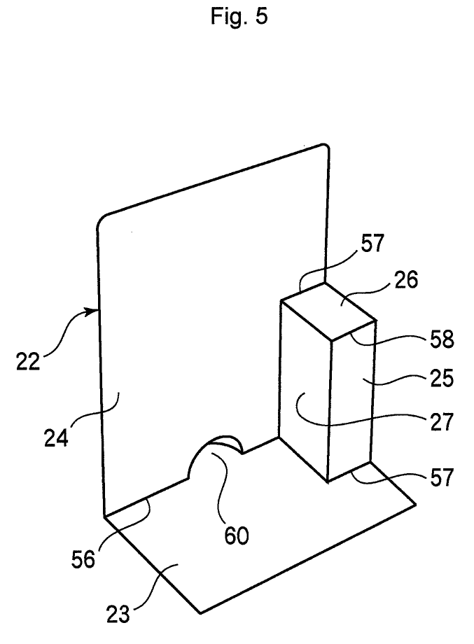

With reference to FIGS. 4 and 5, the assembling operation of the POP 22 is described below. As described above with reference to FIG. 1, in a shop, the outer lid 14 of the package 10 is opened, and the attached fragment 20 is removed from the flap 12 and folded so that the POP 22 is formed. In this folding operation, the first support portion 54 is subjected to a valley fold along the first crease 56 while a semicircular portion 60 enclosed by the semicircular slit 59 is pressed, so that the base plate 23 and the rear surface support plate 24 are formed. At the same time, the second support portion 55 is subjected to valley folds along the second creases 57 and is subjected to a mountain fold along the third crease 58, so that the front wall portion 25 and the upper plate 26 are formed.

The opening 27 defined by the front wall portion 25 and the upper plate 26 is approximately rectangular. A part of the commodity, when placed on the base plate 23, is inserted into the opening 27. Thus, since the part of the commodity is concealed by the front wall portion 25 and the upper plate 26, a photograph of the concealed part may be printed on the front wall portion 25 and the upper plate 26.

As described above, in the present embodiment, packages 10 and attached fragments 20 are formed in a single flexible sheet 40. Therefore, in comparison with a case, in which only the package 10 is formed in a flexible sheet 40, the amount of material disposed of is reduced, so that the efficiency of utilization of the flexible sheet 40 is improved, and thus, the manufacturing costs of the package 10 and the POP 22 are reduced.

Further, in the present embodiment, the attached fragment 20, which does not constitute the package 10, is connected to the flap 12 in such a manner that the attached fragment 20 can be easily cut or separated from the flap 12. Therefore, it is not necessary for a manufacturer to put a POP in every package 10, so that a control such as storage and checking of the POP becomes unnecessary.

The attached fragment 20 is only subjected to a valley fold and a mountain fold along the creases 56, 57, and 58, while pressing the semicircular portion 60, in order that the attached fragment 20 is transformed into the POP 22. Thus, the POP 22 has a simple structure, and can be assembled easily and at low cost. Further, since the rear surface support plate 24 can be formed of a size corresponding to necessity, a space, in which information such as the characteristics of the commodity and so on can be indicated, can be satisfactorily ensured.

When a commodity is placed on the POP 22, the semicircular portion 60 is projected backward from the rear surface support plate 24, so the POP 22 is held in a stable condition. Further, the perforations 21 are concealed by the commodity, so they are prevented from being conspicuous. Note that, if the assembling operation is described on a part of the rear surface support plate 24, which is concealed by the commodity, anyone can assemble the POP 22 easily.

Since the POP 22 is used together with the package 10, it is preferable that information such as the characteristics of the commodity and so on, which is printed on surfaces of the POP 22 and the package 10, is indicated in the same language. Since the present embodiment is constructed in such a manner that the package 10 and the attached sheet 20 are simultaneously printed on a single flexible sheet 40, and the printing process for the package 10 and the attached sheet 20 is performed at the same time, the languages are easily made the same.

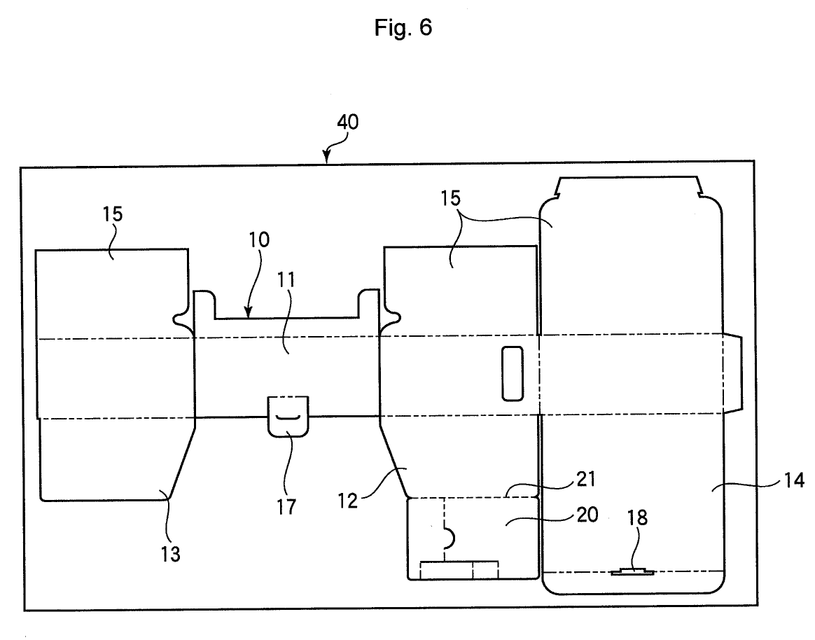

FIG. 6 is a plan view showing a flexible sheet 40, from which the package is cut out, as a second embodiment. In this embodiment, a single package 10 is cut out from a single flexible sheet 40 which is different from the first embodiment, but the other constructions and effects are identical to those of the first embodiment.

Although the embodiments of the present invention have been described herein with reference to the accompanying drawings, obviously many modifications and changes may be made by those skilled in this art without departing from the scope of the invention.

The present disclosure relates to subject matters contained in Japanese Patent Application No. 2006-180106 (filed on Jun. 29, 2006) which is expressly incorporated herein, by reference, in its entirety.

1. A display apparatus for sales promotion, which is formed by folding a sheet, said display apparatus being displayed with a commodity in a shop window, said display apparatus comprising:
a slit that extends within said sheet to have first and second ends; and
first and second support portions that are divided by said slit;
said first support portion being subjected to a valley fold along a first crease line, which perpendicularly extends from said slit between said first and second ends, said second support portion being subjected to a valley fold along second crease lines, which perpendicularly extend from said slit at said first and second ends, whereby an opening is formed, into which part of said commodity can be inserted.

2. A display apparatus according to claim 1, wherein, due to the valley fold in said first support portion, a base plate, which is placed on a horizontal surface, and a rear surface support plate, which is raised from said base plate, are formed.

3. A display apparatus according to claim 1, wherein said second support portion is subjected to a mountain fold along a third crease line, which perpendicularly extends from said slit between said first and second ends.

4. A display apparatus according to claim 1, wherein said first and second support portions have first and second breadths, perpendicular to said slit, said second breadth being less than said first breadth.

5. A display apparatus according to claim 1, wherein said opening is approximately rectangular.

6. A display apparatus according to claim 1, wherein a semicircular slit is formed in said first support portion, both ends of said semicircular slit being positioned on said first crease line.
